(19) United States
(12) Patent Application Publication
(10) Pub. No.: US 2020/0181036 A1
(43) Pub. Date: Jun. 11, 2020

(54) Stable Humus-Water Storage Hybrid

(71) Applicant: Novihum Technologies GmbH, Dresden (DE)

(72) Inventors: Horst NINNEMANN, Froendenberg/Ruhr (DE); Michael SCHLIPF, Goeppingen (DE); André MOREIRA, Witten (DE); Peter LANGER, Hasbergen (DE); Reinhard SORGE, Roitzsch (DE)

(73) Assignee: Novihum Technologies GmbH, Dresden (DE)

(21) Appl. No.: 16/616,445

(22) PCT Filed: May 23, 2018
(86) PCT No.: PCT/EP2018/063443

§ 371 Date: Nov. 22, 2019

(30) Foreign Application Priority Data
May 24, 2017 (EP) 17172661.5

(51) Int. Cl. C05F 11/02; C05C 3/00; C05C 11/00; C05G 3/70; C05G 3/80; A01G 24/23; A01G 24/15; A01G 24/13; A01G 24/25; A01C 21/00

(52) U.S. Cl. CPC C05F 11/02; C05C 3/00; C05C 11/00; C05G 3/70; A01C 21/00; A01G 24/23; A01G 24/15; A01G 24/13; A01G 24/25; C05G 3/80

(57) ABSTRACT

The present invention relates to a stable humus-water storage hybrid comprising an organic fertilizer consisting of lignite treated in an oxidizing and ammoniating manner and at least one water-storing component selected from materials of mineral or organic origin, the proportion of the organic fertilizer amounting to 0.5-99.9 vol. %, preferably 1.0-90.0 vol. %, and the proportion of the at least one water-storing component amounting to 0.1-99.5 vol. %, preferably 10.0-99.0 vol. %. The invention also relates to a method for producing the stable humus-water storage hybrid and to the use thereof as a plant substrate, an additive for planting soil and an additive for soil.

The present invention relates to a stable humus-water storage hybrid comprising an organic fertilizer consisting of lignite treated in an oxidizing and ammoniating manner and at least one water-storing component selected from materials of a mineral or organic origin. The stable humus-water storage hybrid is particularly suitable and intended as an additive for plant substrates.

Stable humus should be understood as an organic substance that is hardly microbially metabolizable and only slowly decomposed. In the soil structure stable humus usually amounts to a large part of the organic soil substance (Schinner F, Sonnleitner R.: “Bodenökologie: Mikrobiologie und Bodenenzymatik Band I: Grundlagen, Klima, Vegetation und Bodentyp”, Springer-Verlag, 1996, page 37, 2.3.5). Stable humus for the most part consists of humic substances, i.e. microbially hardly metabolizable, humified organic substances; thus, the stable humus has a humic substance nature. Humic substances are the fulvic acids, the hymatomelanic acids, the humic acids, and the humins (Fiedler, H. J. and Reissig, H.: “Lehrbuch der Bodenkunde”, Gustav Fischer Verlag Jena, 1964, p. 174 pt. 4.423)

In case of a deficient water supply on locations with less cohesive or non-cohesive soils, i.e. soils with a relatively low proportion of clay/silt (clay: particles<2 μm, silt: 50% of the particles between 0.002 to 0.063 mm) or a relatively high proportion of sand (sand: defined as grain of a diameter between 0.063 to 2 millimeters), problems for the plant growth of crop plants can arise that show in the form of reduced growth efficiency, crop production and up to die-off of the plantations. In the commercial agriculture and horticulture particularly with crop plants in these cases technical expenses and measures are required that partially or completely compensate for the deficiencies of the water supply. These expenses and measures are i.a. employment of irrigation systems that involve the risk of over or under watering or indirect measures such as for example complex shading systems that either permanently reduce the light penetration or have to be controlled to guarantee a sufficient crop production.

A sustainable and long-term possibility to improve the water regime situation of plants on locations with less cohesive or non-cohesive soils is to increase the soil proportion of cohesive materials, i.e. clay- and silt-containing materials or structure-improving organic substances such as farmyard manure, composts and the like. For that, however large amounts of such clay- and silt-materials or organic substances have to be admixed to the soil or the substrate used. The natural availability of these cohesive materials, in particular of the organic substances, is partially limited and therefore, their employment in the amounts needed is associated with considerable costs.

There are a number of suggestions to technically produce products that have properties equivalent to the stable humus.

For example, DE 101 20 433 discloses a method in which upper tertiary soft lignite and clay and/or loam are combined in a certain mass ratio by a common, very intensive and longer acting wet digestion grinding in the required macromolecular distribution. Here, the water by its partial dissolving and swelling effect functions as a dispersing agent and at the same time as a reaction mediator.

DE 198 25 168 suggests to mix raw lignite with various organic fertilizers such as compost, guano, or even mineral NPK fertilizers.

DE 10 2010 005 363 discloses a particle-shaped carbon-based storage material that is able to absorb water, nutrient and microorganisms in which an inorganic carbon component was generated by thermal treatment of coal and/or naturally and/or artificially produced organic compounds under exclusion of oxygen at high temperatures.

US 2014/0069001 discloses a pellet composition containing a seed, coconut fibers, corn flour, activated carbon and an absorbing polymer, for example. The composition may also contain clay or bentonite, for example.

EP 0 561 508 discloses a fertilizer on the basis of leonardite in the production of which leonardite ore is grinded and the grinded leonardite ore particles are treated with an aqueous ammonia solution.

DE 0 870 565 discloses a method for producing nitrogen-rich humus fertilizers by treating younger fossil fuel with air, ammonia, and/or other ammonia-containing gases at an elevated temperature and increased pressure in which fuels with a very low content of water of less than 30% are treated.

U.S. Pat. No. 3,630,710 discloses a fertilizer having a nitrogen-enriched, partially oxidized organic material. The partially oxidized organic material may be coal or even grass, kelp, etc.

WO 2016/116099 describes soil excipients that are to increase the water-holding capacity while simultaneously stimulating the biologic activity for building up a functional soil. It is intended to produce a simple product for use as an aqueous solution or as a substantially solid product for improving the soil-plant water regime. The product of WO 2016/116099 is produced via a method in which a lignite constituent and/or a geological lignite precursor are digested with an acid, later the acid is buffered with a lye, the thus obtained intermediate product is filtered and fulvic acids are added thereto in a proportion of weight of at least 1% relating the finished product. Also, for example bentonite can be added to the thus obtained mixture.

None of the above-mentioned printed matters describes an organic fertilizer of lignite treated in an oxidizing and ammoniating manner as is employed in the stable humus-water storage hybrid products according to the invention. Such products and a method for producing them are provided in EP 1 144 342 (according to WO 00/37394), an improved method for producing them is described later in WO 2017/186852. The products described there are characterized by a carbon-nitrogen ratio of 7 to 15 or 9 to 15, wherein it is substantial that the nitrogen is present chemically differently bound with respect to the total nitrogen, namely 20 to 45% of the nitrogen are present as ammonia nitrogen and 55 to 80% of the nitrogen as organically bound nitrogen. Here, up to 20% of the total nitrogen are present as amide, and up to 60% of the total nitrogen are stably organically bound, i.e. they cannot be hydrolysed as amide.

With an increasing world population and a global decreasing amount of culturable soils nutrition of the population in many regions becomes increasingly problematic. An improvement of soils that otherwise are only hardly (with low crop production) or not at all suitable for growing economically useful plants (but also ornamental plants) could alleviate this problem. Thus, despite the numerous attempts in the prior art to provide favorable soil conditioners and fertilizers there is still a need for an improved product that can be supplied to soils and plants in different ways and that in the long term results in a higher plant growth and crop production as it is possible with the known products.

Thus, the object of the present invention is to provide such a product. In the use as a plant substrate or as an additive for plant substrates and substrate additive for soils, respectively the product is to result in a significant improvement of the increase in crop production even on otherwise “bad” soils and moreover, to be produced cost-effectively and in large scale.

According to the invention, this problem is solved by a stable humus-water storage hybrid comprising an organic fertilizer consisting of lignite treated in an oxidizing and ammoniating manner and at least one water-storing component selected from materials of a mineral or organic origin, the proportion of the organic fertilizer amounting to 0.5-99.9 vol. %, preferably 1.0-90.0 vol. %, and the proportion of the at least one water-storing component amounting to 0.1-99.5 vol. %, preferably 10.0-99.0 vol. %. The organic fertilizer consisting of lignite treated in an oxidizing and ammoniating manner may be obtained for example by a method as described in WO 00/37394 or WO 2017/186852, respectively and thus, in particular by a method comprising the following process steps:
a) converting lignite and aqueous ammonia solution of a pH value greater than 9 to 12 into a suspension and alkaline activating the suspension at first without supplying an oxygen-containing oxidant;
b) feeding the oxygen-containing oxidant into the suspension of lignite and aqueous ammonia solution, wherein the oxidation runs at a reaction temperature<100° C. and a pressure of 0.1-1 MPa;
c) concentrating the product suspension obtained in step b) to a dispersion in the aqueous milieu or drying the product suspension obtained in step b) to a dried product without supplying the oxygen-containing oxidant, and finally cooling, whereby an organic fertilizer is recovered.

Thus produced organic fertilizers consisting of lignite treated in an oxidizing and ammoniating manner have a C/N ration of 7 to 15 and with respect to the total nitrogen, the nitrogen is chemically differently bound, wherein
20-45% are present as ammonium nitrogen,
55-80% are organically bound; and
up to 20% of the total nitrogen are organically bound as amide and
up to 60% are organically bound as not being hydrolysable as amide.

Methods for determining the proportion of the nitrogen being present as ammonium nitrogen and of the nitrogen being present organically bound as well as the proportion of the total nitrogen being present as amide and the proportion being present organically bound as not being hydrolysable as amide are readily known to the skilled person. A suitable method is described i.a. in WO 00/37394 (=EP 1 144 342) to which it is explicitly referred in this context. So, the nitrogen bound in the form of ammonium can easily be cleaved off as ammonia with magnesium oxide suspended in water, while the organic forms of binding are more hardly to hydrolyse. The proportion of the total nitrogen being present in the form of amide can be hydrolysed in a normal manner with diluted sodium hydroxide solution under the conditions of steam distillation. The proportion of the organically bound nitrogen that cannot be hydrolysed under said experimental conditions is the proportion of the total nitrogen that is organically bound as being not hydrolysable as amide.

However, in addition to the above-mentioned and known methods also any other methods familiar to the skilled person due to his/her general expert knowledge can be used.

In the stable humus-water storage hybrid according to the invention the materials of mineral origin are selected from clay minerals, clay minerals-containing substances, perlites, sheet silicates, clay, bentonite, hectorite, montmorillonite, vermiculite, zeolites, sepiolite, attapulgite, calcined clay, expanded clay, expanded shale, volcanic ash, pumice, silica gel, and smectites, and the materials of organic origin are selected from composts, rotten manures, coal-like products, lignocellulose material, wood fibers, wood wool, coconut fibers, hemp fibers, and linen fibers.

The stable humus-water storage hybrid according to the invention results in a significant increase in the plant growth and thus, in crop production, in particular with soils that otherwise could only be cultivated with a low crop production.

According to the definition given above stable humus is an organic substance with humic substance nature that is only hardly microbially metabolizable. Water storages are meant to be porous mineral, in particular clay-mineral, and organic substances. According to the invention hybrid is meant to be the combination of the organic fertilizer and the at least one water-storing component.

As a first constituent the stable humus-water storage hybrid contains an organic fertilizer consisting of lignite treated in an oxidizing and ammoniating manner. Due to its chemical properties and its availability lignite has found interest for quite some time as a starting material for the production of substances and mixtures of substances, respectively with a fertilizing effect. The oxidizing and ammoniating treatment of lignite is an “oxidative ammonolysis”. The oxidative ammonolysis was described, for example by Flaig, et. al. (1959) in “Umwandlung von Lignin in Huminsäuren bei der Verrottung von Weizenstroh” Chem. Ber., 92 8, 1973-1982.

Methods for producing an organic fertilizer consisting of lignite treated in an oxidizing and ammoniating manner are disclosed, for example in EP 1 144 342 A1 and in the international patent application WO 2017/186852 (application number PCT/EP2017/060060). The organic fertilizer of the stable humus-water storage hybrid of the present invention has humic substance nature. In analogy to the humic substance nature of the stable humus (see above) humic substance nature with respect to the organic fertilizer of the stable humus-water storage hybrid of the present invention means that the organic fertilizer to a large extent consists of humic substances. Among humic substances are the fulvic acids, the hymatomelanic acids, the humic acids, and the humins (Fiedler, H. J. and Reissig, H.: “Lehrbuch der Bodenkunde”, Gustav Fischer Verlag Jena, 1964, p. 174 pt. 4.423). In the present case, to a large extent with respect to the humic substance proportion means that the humic substances amount to the largest part of the weight of the organic fertilizer of the stable humus-water storage hybrid of the present invention in a dried state. For example, this means that the humic substances amount to >50% by weight, preferably >60% by weight, more preferred >70% by weight, and especially preferred >80% by weight, of the organic fertilizer of the stable humus-water storage hybrid of the present invention in the dried state.

As used herein, the abbreviations “% by weight” and “vol. %” stand for “percentage by weight” and “percentage by volume”, respectively and indicate the volume and the weight of a proportion based on a total weight and a total volume, respectively. Which proportion it is and on which total weight or total volume it is based is given in the context of the present description of the invention in the appropriate passage.

The use of the organic fertilizer consisting of lignite treated in an oxidizing and ammoniating manner alone improves the water use capacity of plants. However, it has been shown that this is not sufficient for many purposes, in particular if it is required that the plant is supplied for longer term in case of lacking water supply. Surprisingly now it has been shown that the combination of the organic fertilizer with at least one water-storing component, when it is supplied to soils and substrates, synergistically improves the water regime situation and results in a higher increase in the crop production than the organic fertilizer and the at least one water-storing component alone. In the present case, soils are meant to be portions of the uppermost, organic part of the Earth's crust of the mainland. In the present case, substrates are meant to be culture media of all kinds, including the grown earth that is characterized by its respective soil type (Bernhard Berg: Grundwissen des Gärtners. Ulmer, Stuttgart 1976, p. 198-206). Furthermore, substrates are substances that are inserted in vessels (e.g. plant pots) and soil-independent applications (e.g. roof planting) or applied to soil (e.g. in planting holes). There, they serve as root zone for the plants (Verband der Humus- und Erdenwirtschaft).

The stable humus-water storage hybrids of the present invention are improved compared to known products. So, they have a significantly higher content of humic acid compared to the soil conditioners of WO 2016/116099 and the nitrogen is a structural constituent of the humic substance fraction. It has been shown that this is of great importance for the biological usability of the nitrogen.

Thus, the stable humus-water storage hybrid products according to the invention have a temporally differentiated effective nitrogen release compared to the known products which results in a nitrogen long-term effect. This results in a significantly higher crop production of the plants with the same or better quality of the fruits that is achieved over a longer period of time compared to the products of the prior art.

According to the invention, water-storing components are meant to be substances, especially of porous nature, that increase the water capacity of soils and substrates. Water-storing components consisting of materials of mineral origin, in the meaning of the present invention, are porous mineral substances, especially clay-mineral substances (sheet minerals). Water-storing components consisting of materials of organic origin, in the meaning of the present invention, are porous organic substances, such as composts, rotten manures, or charcoal and their derivatives.

In the stable humus-water storage hybrid according to the invention the proportion of the organic fertilizer amounts to 0.5-99.9 vol. %, preferably 1.0-95.0 vol. %, more preferred 1.0-90.0 vol. %, and the proportion of the at least one water-storing component amounts to 0.1-99.5 vol. %, preferably 5.0-99.0 vol. %, more preferred 10.0-99.0 vol. %, each based on the total volume of the stable humus-water storage hybrid.

The organic fertilizer in combination with the water-storing component enables the plants to more efficiently use the water reserves in the substrate. The use of the stable humus-water storage hybrid of the present invention shows its effect in the increase of the water utilization rate, i.e. by using the stable humus-water storage hybrid plants can generate more crop production in case of a deficit water supply than without the stable humus-water storage hybrid. Additionally, water capacity of the substrate or the soil, respectively is increased.

According to the present invention, the materials of mineral origin are to be selected from clay minerals, clay minerals-containing substances, perlites, sheet silicates, clay, bentonite, hectorite, montmorillonite, vermiculite, zeolites, sepiolite, attapulgite, calcined clay, expanded clay, expanded shale, volcanic ash, pumice, silica gel, and smectites. In a particularly preferred embodiment of the present invention the materials of mineral origin are to be selected from bentonite, montmorillonite, clay, calcined clay, expanded clay, and expanded shale. Especially preferred as the material of mineral origin is a sheet silicate such as bentonite.

Bentonite used here contains >50% by weight, preferably 60-80% by weight, of montmorillonite and thus, has a very good swelling capacity that is based on the high inner surface of the sheet silicate of 400-600 m²/g. Preferably, the naturally occurring grinded form of bentonite is used, for example from Landshut extraction areas that are sold by S&B Industrial Minerals GmbH or Clariant.

According to the present invention the water-storing components are to be selected from materials of organic origin selected from composts, rotten manures, coal-like products, lignocellulose material, wood fibers, wood wool, coconut fibers, hemp fibers, and linen fibers.

In a further preferred embodiment of the present invention the materials of organic origin are composts, rotten manures, and charcoal and its derivatives. Especially preferred are composts.

Compost is a humus- and nutrient-rich substance that is formed as a final product in the composting of organic waste and always has a solid consistency. In contrast to the fermentation, the biological processes in composting take place under the action of air oxygen. In this context there is also talk of aerobic treatment or decomposition (Verband der Humus—und Erdenwirtschaft e.V.: www.vhe.de). Rotten manures in the meaning of the present invention especially are rotten droppings and dung (for example, droppings and dung of cows, sheep and horses, etc.), rotten leftover food, and rotten bark-chip mulch. Here, droppings are meant to be the mixture of excrements of animals and a binder such as straw, wood shavings, or hemp chaffs that is a result in agriculture when keeping livestock. Dung in agriculture when keeping livestock is a resulting excrement with a solid proportion. The term “rotten” with respect to manure means the at least partial decomposition and conversion under aerobic, partly aerobic, partly anaerobic, or largely anaerobic conditions. Coal-like products especially comprise charcoal and its derivatives (Schilling, G., 2000. Pflanzenernährung und Düngung, Ulmer Stuttgart).

In an alternative embodiment of the stable humus-water storage hybrid according to the invention the proportion of the organic fertilizer for example amounts to 0.5-60.0 vol. %, preferably 0.5-40.0 vol. %, more preferred 0.5-20.0 vol. %, more preferred 1.0-10.0 vol. %, especially preferred 1.0-5.0 vol. %, and the proportion of the at least one water-storing component for example amounts to 40.0-99.5 vol. %, preferably 60.0-99.5 vol. %, more preferred 80.0-99.5 vol. %, more preferred 90.0-99.0 vol. %, especially preferred 95.0-99.0 vol. %, each based on the total volume of the stable humus-water storage hybrid.

In a further alternative embodiment of the stable humus-water storage hybrid according to the invention the proportion of the organic fertilizer amounts to 1.0-99.0 vol. %, preferably 5.0-99.0 vol. %, more preferred 20.0-99.0 vol. %, more preferred 30.0-95.0 vol. %, 50.0-95.0 vol. %, 60.0-95.0 vol. %, or 70.0-90.0 vol. %, especially preferred about 90.0 vol. %, and the proportion of the at least one water-storing component amounts to 1.0-99.0 vol. %, preferably 1.0-95.0 vol. %, more preferred 1.0-80.0 vol. %, more preferred 5.0-70.0 vol. %, 5.0-50.0 vol. %, 5.0-40.0 vol. %, or 10.0-30.0 vol. %, especially preferred about 10.0 vol. %, each based on the total volume of the stable humus-water storage hybrid.

In still a further alternative embodiment of the stable humus-water storage hybrid according to the invention the proportion of the organic fertilizer amounts to 0.5-99.5 vol. %, preferably 5.0-95.0 vol. %, more preferred 10.0-90.0 vol. %, especially preferred 20.0-80.0 vol. %, and the proportion of the at least one water-storing component amounts to 0.5-99.5 vol. %, preferably 5.0-95.0 vol. %, more preferred 10.0-90.0 vol. %, especially preferred 20.0-80.0 vol. %, each based on the total volume of the stable humus-water storage hybrid.

According to the present invention the organic fertilizer consisting of lignite treated in an oxidizing and ammoniating manner of the stable humus-water storage hybrid has a C/N ratio of 7 to 15, preferably 8 to 15, more preferred 9 to 15, and a nitrogen content of up to 8% by weight, based on the dry weight of the fertilizer. Preferably, the nitrogen content of the organic fertilizer is at least 4% by weight, more preferred at least 5% by weight, and especially preferred at least 6% by weight, each based on the dry weight of the fertilizer.

The nitrogen is present in the organic fertilizer in various chemical binding forms. A part of the nitrogen is present bound in the form of ammonium that is quickly available to the plant. Another part is present bound in stably organically bound binding forms that have a long-term plant availability. Still another part is present in the form of amide that is available to the plant in the medium term.

The chemical binding forms differ in view of their hydrolysability. The nitrogen bound in the form of ammonium can be easily cleaved off as ammonia with MgO suspended in water, while the organic binding forms are more difficult to hydrolyse. The part that is present in the form of amide can be hydrolysed in a normal manner with diluted sodium hydroxide solution under the conditions of steam distillation. The proportion that cannot be hydrolysed under these experimental conditions represents the solid, organically bound nitrogen.

According to the present invention the organic fertilizer has a C/N ratio of 7 to 15 and compared to the total nitrogen, the nitrogen is present chemically differently bound, from which 20-45% are present as ammonium nitrogen, 55-80% are organically bound, from which up to 20% of the total nitrogen are organically bound as amide and up to 60% are organically bound as not being hydrolysable as amide.

The production method of the organic fertilizer consisting of lignite treated in an oxidizing and ammoniating manner of the stable humus-water storage hybrid according to the invention is not particularly limited. In one embodiment of the present invention the organic fertilizer consisting of lignite treated in an oxidizing and ammoniating manner of the stable humus-water storage hybrid according to the invention can be obtained according to a method comprising the following steps:
a) converting lignite and aqueous ammonia solution of a pH value greater than 9 to 12 into a suspension and alkaline activating the suspension at first without supplying an oxygen-containing oxidant;
b) feeding the oxygen-containing oxidant into the suspension of lignite and aqueous ammonia solution, wherein the oxidation runs at a reaction temperature<100° C. and a pressure of 0.1-1 MPa;
c) concentrating the product suspension obtained in step b) to a dispersion in the aqueous milieu or drying the product suspension obtained in step b) to a dried product without supplying the oxygen-containing oxidant, and finally cooling, whereby an organic fertilizer is recovered.

The aqueous ammonia solution used in step a) can be recovered by dissolving ammonia in water. The aqueous ammonia solution or their raw materials water and ammonia can be recovered from the reaction process, especially from steps b) and step c), and again provided to the method, what contributed to the economic efficiency of the method.

The aqueous ammonia solution in step a) preferably has a concentration of up to 10% by weight, wherein the concentration is preferably at least 2% by weight, each based on the total weight of the aqueous ammonia solution. More preferred is a concentration of 3 to 8% by weight, and especially preferred is a concentration of 4 to 6% by weight, each based on the total weight of the aqueous ammonia solution.

The lignite can be used with different particle sizes and altogether can be reacted without previous separation operations. It is possible to use lignites of different locations (origin) as a starting material. Moreover, lignite can be used in a mixture with technical lignins of the pulp industry as well as of wood hydrolysis, lignite in a mixture with lignin as well as a lignocellulose material from the steam explosion pulping for production of fibers, and lignite in a mixture with a lignocellulose material such as wood and bark particles. Said mixtures can be used pre-mixed or obtained by mixing the individual constituents and the aqueous ammonia solution in step a).

Oxidation in step b) can be carried out in an aqueous ammoniacal milieu at an ammonia concentration of up to 7%. In one embodiment the oxygen-containing oxidant is to be selected from air, oxygen, air/oxygen mixtures, ozone, or hydrogen peroxide. Furthermore, in the course of the oxidation in step b) catalysts can be used that increase the activity of the oxidant.

Oxidation in step b) preferably takes place over a period of 15 to 300 min, more preferred 30 to 240 min, especially preferred 45 to 120 min. By the oxidation of the suspension obtained from step a) in this time interval with the oxygen-containing oxidant there is formed a suspension that comprises the oxidation product of the suspension obtained from step a). Preferably, the oxygen-containing oxidant is directly introduced into the suspension, for example in case of a gaseous oxidant by feeding the gas into the reaction mixture under excessive pressure. The suspension resulting from step b) in the context of the method is referred to as “product suspension” that contains the oxidation product.

The cooled product obtained in step c) is an organic fertilizer consisting of lignite treated in an oxidizing and ammoniating manner in the meaning of the present invention. Preferably, the organic fertilizer is the dried product. As described above, said organic fertilizer has a humic substance nature and preferably a nitrogen content of up to 8% by weight, based on the dry weight of the fertilizer, and a C/N ratio of 7 to 15, especially preferred a C/N ratio of 9 to 15. The so produced organic fertilizer moreover preferably has a residual moisture content of at most 35% by weight, based on the total weight of the organic fertilizer.

The method for the production of the organic fertilizer can be technologically implemented in such a way that, as described in EP 1 144 342 (WO 00/37394), the lignite is converted into a suspension with an aqueous ammonia solution having a pH value greater than 9 to 12 and subsequently is activated alkaline in a reactor at first without the supply of oxygen or air and in doing so is brought to an oxidation temperature of less than 100° C. in a period of time that can be controlled up to 0.5 hrs, subsequently the oxygen-containing oxidant, which is an oxidizing gas, at a reaction temperature below 100° C. and with air or oxygen as an oxidizing gas under normal pressure and with air/oxygen mixtures as the oxidizing gas at normal pressure with an oxygen partial pressure in the range of from 0.02 MPa to <0.1 MPa is fed into the reaction mixture each according to the principle of injection and finally the supply of the oxidizing gas is closed and the reaction is stopped and subsequently the reaction mixture (product mixture) is cooled to a temperature that is needed for the further processing without further supply of oxidizing gas, with the cooling time being less than 1 h, and the organic fertilizer is recovered as a dispersion in the aqueous milieu by concentrating or drying, with a C/N ratio of 9 to 15 being obtained. Regarding specific process steps of such a process implementation reference is made to EP 1 144 342 (WO 00/37394).

In the international patent application WO 2017/186852 (application number PCT/EP2017/060060) the method of EP 1 144 342 was further developed to a continuous method, with the raw materials lignite and aqueous ammonia solution being continuously fed into the method and the reaction need not be discontinued. In this way, the organic fertilizer can be produced with a high throughput of the raw materials and low energy demand.

Accordingly, in a further embodiment of the present invention the organic fertilizer consisting of lignite treated in an oxidizing and ammoniating manner of the stable humus-water storage hybrid according to the invention is produced by a continuous method as described in WO 2017/186852, comprising the following steps:
a) supplying lignite particles and an aqueous ammonia solution as well as optionally recovered product of step b) as raw materials into a dispersion cycle with a dispersing device, a recirculation container, and a circulation pump, and dispersing the raw materials while simultaneously milling the lignite particles until a suspension of lignite particles and the aqueous ammonia solution is formed that is taken out of the dispersion cycle and supplied to step b);
b) oxidizing the suspension obtained in step a) in an oxidation reactor with an oxygen-containing oxidant at a temperature of <100° C., whereby a product suspension is formed that is completely supplied to step c) or partially to step c) and partially to step a) as raw material;
c) drying the product suspension obtained in step b) at a temperature >50° C. to a residual moisture content of at most 30% by weight, based on the total weight of the dried product and cooling the obtained dried product;
   wherein the organic fertilizer has a nitrogen content of up to 8% by weight, based on the dry weight of the fertilizer, and a C/N ratio of 7 to 15.

In the present case, the term “continuous method” is meant to be such that continuously starting materials, that in the present case especially are lignite and an aqueous ammonia solution as well as an optionally recovered product suspension of step b), are supplied to the method that are converted into a dried and cooled organic fertilizer as a product via steps a) to c) without having to interrupt the method or process steps, respectively to form the organic fertilizer and remove it from the process.

As used herein, the term “dispersion cycle” indicated an assembly comprising a dispersing device, a recirculation container, and a circulation pump. The dispersing device preferably is a closed system, so that gas exchange with the environment is prevented. Preferably, the average retention time of the mixture of lignite particles and the aqueous ammonia solution as well as optionally recovered product of step b) in the dispersing device is 30 to 300 min, more preferred 45 to 240 min, especially preferred 60 to 180 min, before the resulting suspension is taken out of the dispersion cycle and is supplied to step b). The average retention time is calculated as is common in the continuous process control from the total volume of the dispersing device and the supplied and withdrawn volumes (e.g., in case of a volume of the dispersing device of 100 l and a supply and withdrawal of 25 l/h the average retention time would be 4 h).

The continuous method permits the use of lignite particles as a starting product the size of which does not play a decisive role, since the lignite particles are milled during the method. For practical reasons there are preferably used lignite particles of average particle sizes of >10 μm during the continuous method, wherein lignite particles of particle sizes of e.g. up to 10 mm may also be used. More preferred are lignite particles of particle sizes up to 5 mm, even more preferred up to 2 mm, still more preferred up to 1 mm, even more preferred up to 500 μm, especially preferred up to 100 μm. Preferably, the lignite particles are lignite dust of typical average particle sizes in the range of from >10 to 600 μm, especially in the range of from 200 to 300 μm, i.e. currently common commercial lignite dust. However, in the course of the continuous method e.g. also the use of raw lignite of particle sizes up to 10 mm is possible, wherein the raw lignite is milled in the dispersion cycle, especially in the dispersing device.

The dispersing device is a mixing device and a milling device at the same time, wherein the mixture of lignite particles and an aqueous ammonia solution as well as optionally recovered product of step b) is mixed in the dispersing device by simultaneously milling the lignite particles until a suspension of milled lignite particles and the aqueous ammonia solution is formed. By milling the lignite particles in the dispersing device, lignite particles having a relatively uniform particle size distribution can be obtained, which permits the formation of a particularly homogeneous suspension that is supplied to oxidation in step b).

Preferably, the lignite particles are milled in the dispersing device to an average particle size of ≤10 μm, more preferred to an average particle size of <8 μm, even more preferred to an average particle size of <6 μm, and especially to an average particle size of <4 μm. Milling of the lignite particles has the advantage that the reaction surfaces are significantly increased and the average size distribution is relatively uniform, which benefits the oxidation reaction carried out in step b).

If there is used a gas as the oxygen-containing oxidant, i.e. for example oxygen, oxygen-enriched air, air, or ozone, so this in the continuous method is preferably directly fed into the suspension with an excessive pressure of up to 0.8 MPa by means of a gas metering device. In the context of the present invention “excessive pressure” means that the pressure with which the oxygen-containing oxidizing gas is supplied is over normal pressure. Normal pressure corresponds to a pressure of 101325 Pa=1.01325 bar. Accordingly, in the course of the continuous method the oxygen-containing gas is supplied with a pressure of >0.101325 MPa, wherein the oxygen-containing gas can also be supplied with an excessive pressure of up to 0.8 MPa. Preferably, the oxygen-containing gas is supplied with an excessive pressure of at least 0.15 MPa. More preferred is an excessive pressure of 0.2 to 0.8 MPa, even more preferred an excessive pressure of 0.3 to 0.7 MPa, and especially preferred an excessive pressure of 0.4 to 0.6 MPa.

For example, the gas metering device may be a die lance, a gassing ring, or a gassing agitator that are located in the reactor and are in contact with the suspension or immerse into it, respectively. Preferably, the gas metering device is a gassing agitator with which the suspension at the same time can be stirred in the reactor, what benefits the feeding of the oxygen-containing oxidizing gas into the suspension and thus the oxidation reaction.

Alternatively, the oxygen-containing oxidant may also be added in solution, for example in the form of an aqueous hydrogen peroxide solution. Furthermore, gaseous oxidants in solution, preferably in aqueous solution, can be added.

In general, the oxidation reactor also operates under excessive pressure that is slightly lower than the pressure with which the oxygen-containing gas is introduced (if such is introduced). Preferably, the oxidation reactor operates under a pressure of more than 0.101325 MPa (normal pressure) to 0.7 MPa, more preferred to 0.6 MPa.

Drying in step c) of the continuous method is carried out at a temperature of >50° C., preferably >60° C., especially preferred >70° C., with the maximum temperature preferably being 120° C. The average retention time for drying is generally below 20 hours, preferably below 10 hours, more preferred below 8 hours. Cooling of the product preferably takes place in a rotating drum. Preferably, the dried product is cooled to a temperature of less than 50° C., especially preferred to room temperature (20 to 30° C.). The duration of cooling is usually 10 to 240 min, preferably 20 to 180 min, especially preferred 30 to 120 min.

Regarding further aspects in terms of procedure of the continuous production method of the organic fertilizer reference is made to the description of WO 2017/186852 and the printed matter cited there.

According to an alternative embodiment of the present invention the stable humus-water storage hybrid comprises at least two water-storing components. According to a further alternative embodiment the stable humus-water storage hybrid comprises at least two water-storing components, wherein the at least two water-storing components comprise at least one water-storing material of mineral origin and at least one water-storing material of organic origin.

The stable humus-water storage hybrid according to the invention can be advantageously used in different ways. Especially, the stable humus-water storage hybrid according to the invention is used as a plant substrate, as an additive for planting soil, and as a substrate additive for soil-conditioning for substrates and soils that are poor in carbon, need stable humus or can be conditioned with stable humus and are permeable and in need of conditioning with respect to the water regime. Such a use of the stable humus-water storage hybrid according to the invention surprisingly results in a larger increase in crop production than the organic fertilizer or the at least one water-storing component alone. Said increase in crop production is in addition to the effect resulting from the addition of ordinary fertilizer, such as NPK liquid fertilizer, since the increase in crop production can also be observed with the simultaneous addition of liquid fertilizer, for example. In a further embodiment of the present invention the use of the stable humus-water storage hybrid according to the invention results in an increase in crop production of >10%, preferably >15%, compared to the organic fertilizer or the at least one water-storing component alone.

Moreover, the use of the stable humus-water storage hybrid according to the invention as a plant substrate, an additive for planting soil, or a substrate additive for soil-conditioning surprisingly results in a lower water consumption than with the organic fertilizer or the at least one water-storing component alone.

The use of the stable humus-water storage hybrid according to the invention as a plant substrate, an additive for planting soil, or a substrate additive for soil-conditioning surprisingly further results in an increased water capacity and an improved water utilization rate of plants compared to the organic fertilizer or the at least one water-storing component alone.

When using the stable humus-water storage hybrid according to the invention on less cohesive or non-cohesive soils having a low proportion of fines the stable humus-water storage hybrid according to the invention can particularly well unfold its beneficial effect.

If the stable humus-water storage hybrid according to the invention is used as a plant substrate the at least one water-storing component comprises at least one material of organic origin. Here, the at least one material of organic origin is to be selected from composts, rotten manures, coal-like products, lignocellulose material, wood fibers, wood wool, coconut fibers, hem fibers, and linen fibers, preferably from composts and rotten manures.

When using the stable humus-water storage hybrid according to the invention as a plant substrate the proportion of the organic fertilizer for example amounts to 0.5-60.0 vol. %, preferably 0.5-40.0 vol. %, more preferred 0.5-20.0 vol. %, more preferred 1.0-10.0 vol. %, especially preferred 1.0-5.0 vol. %, and the proportion of the at least one material of organic origin for example amounts to 40.0-99.5 vol. %, preferably 60.0-99.5 vol. %, more preferred 80.0-99.5 vol. %, more preferred 90.0-99.0 vol. %, especially preferred 95.0-99.0 vol. %, each based on the total volume of the stable humus-water storage hybrid. How to use the stable humus-water storage hybrid according to the invention as a plant substrate is basically not different from the use of conventional plant substrates in agriculture and market garden and is known to the skilled person.

When the stable humus-water storage hybrid according to the invention is used as an additive for planting soil the proportion of the organic fertilizer amounts to 1.0-99.0 vol. %, preferably 5.0-99.0 vol. %, more preferred 10.0-95.0 vol. %, more preferred 30.0-95.0 vol. %, 50.0-95.0 vol. %, 60.0-95.0 vol. % or 70.0-90.0 vol. %, especially preferred about 90.0 vol. %, and the proportion of the at least one water-storing component amounts to 1.0-99.0 vol. %, preferably 1.0-95.0 vol. %, more preferred 5.0-90.0 vol. %, more preferred 5.0-70.0 vol. %, 5.0-50.0 vol. %, 5.0-40.0 vol. % or 10.0-30.0 vol. %, especially preferred about 10.0 vol. %, each based on the total volume of the stable humus-water storage hybrid. How to use the stable humus-water storage hybrid as an additive for planting soil is basically not different from the use of conventional additives in agriculture and marked garden and is known to the skilled person. The planting soil thus laced with additives in turn can be used as a plant substrate, for example in the agricultural or horticultural cultivation of plants.

When using the stable humus-water storage hybrid according to the invention as an additive for planting soil the stable humus-water storage hybrid preferably amounts to 0.1-90.0 vol. %, more preferred 0.1-30.0 vol. %, more preferred 0.5-20.0 vol. %, especially preferred 1.0-10.0 vol. % of the planting soil.

When using the stable humus-water storage hybrid according to the invention as a substrate additive for soil-conditioning the proportion of the organic fertilizer amounts to 0.5-99.5 vol %, preferably 5.0-95.0 vol. %, more preferred 10.0-90.0 vol. %, especially preferred 20.0-80.0 vol. %, and the proportion of the at least one water-storing component amounts to 0.5-99.5 vol. %, preferably 5.0-95.0 vol. %, more preferred 10.0-90.0 vol. %, especially preferred 20.0-80.0 vol. %, each based on the total volume of the stable humus-water storage hybrid. How to use the stable humus-water storage hybrid as a substrate additive for soil-conditioning for substrates and soils that are poor in carbon, need stable humus or can be conditioned with stable humus and are permeable and in need of conditioning with respect to the water regime is basically not different from the use of a conventional substrate additive for soil-conditioning and increasing the crop production in agriculture and marked garden and is known to the skilled person.

The stable humus-water storage hybrid according to the invention as a substrate additive for soil-conditioning for example, for substrates and soils that are poor in carbon, need stable humus or can be conditioned with stable humus and are permeable and in need of conditioning with respect to the water regime is preferably to be used such that it amounts to 0.1-90.0% by weight, preferably 0.1-30.0% by weight, more preferred 0.1-15.0% by weight, more preferred 0.1-10.0% by weight, especially preferred 1.0-10.0% by weight of the uppermost ca. 20 cm thick soil layer. Substrates and soils that are poor in carbon, need stable humus or can be conditioned with stable humus and are permeable and in need of conditioning with respect to the water regime are for example substrates or soils of a high content of sand and/or gravel, a small proportion of an organic soil substance and a high water permeability. The stable humus-water storage hybrid according to the invention can be applied to such substrates and soils that are poor in carbon, need stable humus or can be conditioned with stable humus and are permeable and in need of conditioning with respect to the water regime or fed into a depth of 15-20 cm. In a preferred form of usage, the stable humus-water storage hybrid is fed into a depth of 20 cm. Here, the individual components of the stable humus-water storage hybrid may be applied or fed in alone, combined during application or feeding in, or applied or fed in in a premixed form.

A further aspect of the present invention is a method for the production of a stable humus-water storage hybrid comprising the following method steps:
a) converting lignite and aqueous ammonia solution of a pH value greater than 9 to 12 into a suspension and alkaline activating the suspension at first without supplying an oxygen-containing oxidant;
b) feeding the oxygen-containing oxidant into the suspension of lignite and aqueous ammonia solution, wherein the oxidation runs at a reaction temperature<100° C. and a pressure of 0.1-1 MPa;
c) concentrating the product suspension obtained in step b) to a dispersion in the aqueous milieu or drying the product suspension obtained in step b) to a dried product without supplying the oxygen-containing oxidant, and finally cooling, whereby an organic fertilizer is recovered;
d) combining or mixing, at least one water-storing component to be selected from materials of mineral or organic origin with the product suspension or the organic fertilizer of step c) whereby the stable humus-water storage hybrid is obtained;
   wherein in the thus produced stable humus-water storage hybrid the proportion of the organic fertilizer amounts to 0.5-99.9 vol. %, preferably 1.0-90.0 vol. %, and the proportion of the at least one water-storing component amounts to 0.1-99.5 vol. %, preferably 10.0-99.0 vol. %, each based on the total volume of the stable humus-water storage hybrid, wherein the organic fertilizer has a C/N ratio of 7 to 15 and with respect to the total nitrogen, the nitrogen is present chemically differently bound, wherein
20-45% are present as ammonium nitrogen,
55-80% are organically bound; and
up to 20% of the total nitrogen are organically bound as amide and
up to 60% of the total nitrogen are organically bound as not being hydrolysable as amide,
   the materials of mineral origin are selected from clay minerals, clay minerals-containing substances, perlites, sheet silicates, clay, bentonite, hectorite, montmorillonite, vermiculite, zeolites, sepiolite, attapulgite, calcined clay, expanded clay, expanded shale, volcanic ash, pumice, silica gel, and smectites and the materials of organic origin are selected from composts, rotten manures, coal-like products, lignocellulose material, wood fibers, wood wool, coconut fibers, hemp fibers, and linen fibers.

The meaning of “combining” in step d) of the production method is to be interpreted broader than “mixing” and comprises immediately mixing, but also portioning of the individual constituents of the stable humus-water storage hybrid, especially of the organic fertilizer and the at least one water-storing component, in amounts that correspond to the volume proportions in the hybrid according to the invention, and finally mixing or combining before or when using as a plant substrate, additive for planting soil, or substrate additive in substrates and soils that are poor in carbon, need stable humus or can be conditioned with stable humus and are permeable and in need of conditioning with respect to the water regime. In one embodiment of the production method of the stable humus-water storage hybrid mixing of the organic fertilizer and the at least one water-storing component takes place during drying or cooling of the organic fertilizer in step c) or subsequently. In an alternative embodiment of the production method the at least one water-storing component and the organic fertilizer are portioned in such amounts that they correspond to volume proportions of the hybrid according to the invention that are finally mixed just before or during use. Portioning according to the invention is meant to be actually portioning of the individual components of the hybrid or as a usage instruction indicating in which amounts (portions) the individual components of the hybrid are to be mixed or combined in the use according to the invention. Preferably, “combining” with respect to the method according to the invention means “mixing”.

In step d) there can also be used two, three, four, etc. water-storing components, wherein then preferably at least one water-storing component is of mineral origin and at least one water-storing component of organic origin.

Regarding aspects in term of procedure and specific embodiments of process steps a) to c) reference is made to the detailed description of the method for the production of the organic fertilizer of the stable humus-water storage hybrid according to the invention (see above).

The stable humus-water storage hybrid that can be obtained by the production method according to the invention has the above-described product features of the stable humus-water storage hybrid according to the invention, especially the surprising advantageous properties showing in use as a plant substrate, an additive for planting soil, or a substrate additive for soil-conditioning.

### EXAMPLES

### Example 1

Various stable humus-water storage hybrids according to the invention have been produced. For that, water-storing, porous, swellable materials—composts, plant chips, coconut, rocks, minerals, mineral products, and Novihum® (Novihum® is the trade name of an organic fertilizer consisting of lignite treated in an oxidizing and ammoniating manner; the production may take place as described in EP 1 144 342 (i.e. WO 00/37394))—be it as a mixture or in combination—have been added to agricultural or horticultural planting substrates and mixed. Alternatively, stable humus-water storage hybrids according to the invention have been produced from composts, plant chips, coconut, rocks, minerals, mineral products, and Novihum® directly as independent agricultural or horticultural planting substrates for crop growing, wherein said hybrids for use as plant substrates comprised at least one water-storing component consisting of materials of organic origin, such as composts, plant chips, or coconut. Water-storing, swellable rocks and minerals or mineral products are clay minerals, clay minerals-containing substances (e.g. bentonite), processed minerals and rocks such as expanded clay or expanded shale. The proportion of Novihum® was between 1 vol. % and 99 vol. %. As a plant substrate additive for the uppermost 20 cm thick soil layer the application rate of the mixture or the combination amounts to between 0.1% by weight and 10% by weight. As an additive for planting soil or as an independent plant substrate the application rate of the mixture or the combination amounts to between 0.1 vol. % and 100 vol. %.

The novihum product had the composition given in WO 00/37394, Example 1, i.e. according to the elemental analysis:
C=53.50%
H=5.32%
N=5.97%
S=0.45%.

Thus, the C/N rate was 8.96. The binding forms of the nitrogen (in % of the total nitrogen content) were:
ammonium nitrogen=32.8%
organically bound nitrogen=67.2%
amide nitrogen=11.1%
stably organically bound nitrogen=56.1%.

Accordingly, the products of the further examples of WO 00/37394 can also be used, and their use results in comparable or better results.

TABLE 1
Examples of Use

| | | | | Proportion of the | |
|---|---|---|---|---|---|
| | Novihum ® water | | | combination in use | |
| | storage combination | | | Proportion of | Proportion of |
| | Water | | | topsoil layer | plant |
| | storage, | | | (% by | substrate/ |
| | Proportion | Novihum | Example of | weight/ | mould |
| No. | (vol. %) | (vol. %) | Application | 20 cm) | (vol. %) |
| A | 99% | 1% | planting | — | 100% ⁽¹⁾ |
| | | | substrate | | |
| | | | for crop | | |
| | | | growing | | |
| B | 80% | 20% | addition to | 10% | — |
| | | | permeable | | |
| | | | soil poor | | |
| | | | in carbon | | |
| C | 20% | 80% | addition to | 2% | — |
| | | | permeable | | |
| | | | soil poor | | |
| | | | in carbon | | |
| D | 10% | 90% | additive | — | 4% |
| | | | for | | |
| | | | planting | | |
| | | | soil | | |

⁽¹⁾ When using the stable humus-water storage hybrid as a plant substrate at least one water-storing component of organic origin is employed.

### Example 2

Example of Use for Hybrid Consisting of an Organic Fertilizer and an Organic Water Storage

For comparison, four test variants with snake cucumbers were compared in a sandy soil in the protected cultivation (evaporation-cooled green house). As the organic fertilizer consisting of lignite treated in an oxidizing and ammoniating manner Novihum® was used and as the water-storing component of organic origin bovine dung compost was used:

Variant 1:

0.5 kg/m² of Novihum® as well as 1.0 kg/m² of bovine dung compost were worked in 15 cm deep into the soil surface.

Variant 2:

1.0 kg/m² of bovine dung compost were worked in 15 cm deep into the soil surface.

Variant 3:

0.5 kg/m² of Novihum® were worked in 15 cm deep into the soil surface.

Variant 4:

Neither Novihum® nor bovine dung compost were worked in. There was only supplied water and nutrients in analogy to variants 1 to 3.

All of the variants received the same amounts of nutrient and water. The duration of the cultivation was 3 months.

TABLE 2
Novihum ® Compost Hybrid

| | Variant 1 | Variant 2 | Variant 3 | Variant 4 |
|---|---|---|---|---|
| Novihum ® (0.5 kg/m²) | + | − | + | − |
| Compost (1 kg/m²) | + | + | − | − |
| fertilization (NPK liquid) | + | + | + | + |
| crop production (kg/m²) | 1.08 | 0.93 | 0.76 | 0.61 |
| crop production | 77% | 52% | 25% | 0% |
| difference to V4 | | | | |

+: constituent added;
−: constituent not added;
NPK liquid: nitrogen phosphate potassium liquid fertilizer

Surprisingly, variant 1 showed that the combination of Novihum® and a water storage of organic origin had an additive crop production-increasing effect that was greater than the effect of the individual components. In all of the four test variants additionally ordinary liquid fertilizer (NPK liquid fertilizer) was used. Thus, the crop production-increasing effect is additionally to the increase in crop production that is achieved by ordinary liquid fertilizer. The comparison of variant 1 and variant 2 also showed that the combination of an organic fertilizer and a water storage of organic origin yielded a 16% or 42% higher crop production than the water storage of organic origin or the organic fertilizer alone.

### Example 3

Example of Use for Hybrid Consisting of Organic Fertilizer and Mineral Water Storage

For comparison, four test variants were compared on a sandy, very water-permeable soil. As the test culture garden lawn was used. As the organic fertilizer consisting of lignite treated in an oxidizing and ammoniating manner Novihum® was used and as the water-storing component of mineral origin bentonite was used. The supply of nutrients and water was the same for all variants:
Variant 1: 0.5 kg/m² of Novihum® and 0.5 kg/m² of bentonite
Variant 2: 1.0 kg/m² of Novihum®
Variant 3: 1.0 kg/m² of bentonite
Variant 4: untreated

As results from the represented experimental set-up, the same total amounts each of Novihum®, the water storage, and Novihum®+water storage were used. Six weeks after the lawn seeding the four variants were checked for the coverage (proportion of the surface covered by vegetation), sprouting result (proportion of the germinated seed in the total seed amount) and overall impression (color, density, leave shape).

Six weeks after the lawn seeding there were shown the following findings:
A) The coverage decreased in the order of variants 1,3,2,4.
B) The sprouting result decreased in the order of variants 1,3,2=4.
C) The overall impression decreased in the order of variants 1,3,2,4.

As shown by result B) sprouting result the stable humus-water storage hybrid consisting of organic fertilizer and water storage of mineral origin has a synergistic effect compared to the stable humus and the water storage alone. Analogue results are shown for hybrids consisting of Novihum® and clay granules, charcoal, or expanded shale. For other substances that are equal with respect to porosity and water storage capacity comparable results are to be expected.

1. A stable humus-water storage hybrid product comprising an organic fertilizer consisting of lignite subjected to an oxidizing and ammoniating treatment and at least one water-storing component selected from materials of a mineral or organic origin, the proportion of the organic fertilizer is 0.5-99.9 vol. %, and the proportion of the at least one water-storing component is 0.1-99.5 vol. %, each based on the total volume of the stable humus-water storage hybrid product, wherein
the organic fertilizer has a C/N ratio of 7 to 15 and wherein
20-45% of the total nitrogen are present as ammonium nitrogen,
55-80% of the total nitrogen are organically bound,
up to 20% of the total nitrogen are organically bound as amide and
up to 60% of the total nitrogen are organically bound as not being hydrolysable as amide, wherein
the materials of mineral origin are selected from clay minerals, clay minerals-containing substances, perlites, sheet silicates, clay, bentonite, hectorite, montmorillonite, vermiculite, zeolites, sepiolite, attapulgite, calcined clay, expanded clay, expanded shale, volcanic ash, pumice, silica gel, and smectites and
the materials of organic origin are selected from composts, rotten manures, coal-like products, lignocellulose material, wood fibers, wood wool, coconut fibers, hemp fibers, and linen fibers.

2. The stable humus-water storage hybrid product according to claim 1, wherein the proportion of the organic fertilizer is 0.5-20.0 vol. %, and the proportion of the at least one water-storing component is 80-99.5 vol. %.

3. The stable humus-water storage hybrid product according to claim 1, wherein the proportion of the organic fertilizer is 20.0-99.0 vol. %, and the proportion of the at least one water-storing component is 1.0-80.0 vol. %.

4. The stable humus-water storage hybrid product according to claim 1, wherein the proportion of the organic fertilizer is 0.5-99.5 vol. %, and the proportion of the at least one water-storing component is 0.5-99.5 vol. %.

5. The stable humus-water storage hybrid product according to claim 1, wherein the organic fertilizer is obtained by a method comprising the following process steps:
a) converting lignite and an aqueous ammonia solution having a pH value of greater than 9 to 12 into a suspension and alkaline activating the suspension at first without supplying an oxygen-containing oxidant;
b) feeding an oxygen-containing oxidant into the suspension of lignite and aqueous ammonia solution to oxidize the suspension and form a product suspension, wherein the oxidation runs at a reaction temperature<100° C. and a pressure of 0.1-1 MPa; and
c) concentrating the product suspension obtained in step b) to obtain a dispersion in an aqueous medium or drying the product suspension obtained in step b) to obtain a dried product without supplying the oxygen-containing oxidant, and finally cooling, whereby an organic fertilizer is recovered.

6. A method for increasing crop production comprising using the stable humus-water storage hybrid product according to claim 1 as an additive for planting soil or as a substrate additive for soil-conditioning for substrates and soils that are poor in carbon, need stable humus or can be conditioned with stable humus and are permeable and in need of conditioning with respect to water.

7. The method according to claim 6, wherein the hybrid product is used as an additive for planting soil, and wherein the hybrid product amounts to 0.1-90.0 vol. % of the planting soil.

8. The method according to claim 6, wherein the hybrid product is used as a substrate additive for soil-conditioning for substrates and soils, and wherein the hybrid product amounts to 0.1-90.0% by weight of the uppermost 20 cm thick soil layer.

9. A method of increasing crop production comprising using the stable humus-water storage hybrid product according to claim 1 as a plant substrate, wherein the at least one water-storing component comprises at least one material of an organic origin.

10. A method for producing a stable humus-water storage hybrid product comprising the following process steps:
a) converting lignite and an aqueous ammonia solution having a pH value of greater than 9 to 12 into a suspension and alkaline activating the suspension at first without supplying an oxygen-containing oxidant;
b) feeding an oxygen-containing oxidant into the suspension of lignite and aqueous ammonia solution to oxidize the suspension and form a product suspension, wherein the oxidation runs at a reaction temperature<100° C. and a pressure of 0.1-1 MPa;
c) concentrating the product suspension obtained in step b) to obtain a dispersion in an aqueous medium or drying the product suspension obtained in step b) to obtain a dried product without supplying the oxygen-containing oxidant, and finally cooling, whereby an organic fertilizer is recovered; and
d) combining or mixing at least one water-storing component selected from materials of mineral or organic origin with the product suspension or the organic fertilizer of step c) whereby the stable humus-water storage hybrid product is obtained;
wherein in the thus produced stable humus-water storage hybrid product, the proportion of the organic fertilizer is 0.5-99.9 vol. %, and the proportion of the at least one water-storing component is 0.1-99.5 vol. %, each based on the total volume of the stable humus-water storage hybrid product, wherein the organic fertilizer has a C/N ratio of 7 to 15 and wherein
20-45% of the total nitrogen are present as ammonium nitrogen,
55-80% of the total nitrogen are organically bound,
up to 20% of the total nitrogen are organically bound as amide and
up to 60% of the total nitrogen are organically bound as not being hydrolysable as amide, wherein
the materials of mineral origin are selected from clay minerals, clay minerals-containing substances, perlites, sheet silicates, clay, bentonite, hectorite, montmorillonite, vermiculite, zeolites, sepiolite, attapulgite, calcined clay, expanded clay, expanded shale, volcanic ash, pumice, silica gel, and smectites and
the materials of organic origin are selected from composts, rotten manures, coal-like products, lignocellulose material, wood fibers, wood wool, coconut fibers, hemp fibers, and linen fibers.

11. A stable humus-water storage hybrid product obtained by the method according to claim 10.

12. The stable humus-water storage hybrid product according to claim 1, wherein the proportion of the organic fertilizer is 1.0-90.0 vol. %, and the proportion of the at least one water-storing component is 10.0-99.0 vol. %.

13. The stable humus-water storage hybrid product according to claim 2, wherein the proportion of the organic fertilizer is 1.0-10.0 vol. %, and the proportion of the at least one water-storing component is 90.0-99.0 vol. %.

14. The stable humus-water storage hybrid product according to claim 13, wherein the proportion of the organic fertilizer is 1.0-5.0 vol. %, and the proportion of the at least one water-storing component is 95.0-99.0 vol. %.

15. The stable humus-water storage hybrid product according to claim 3, wherein the proportion of the organic fertilizer is 50.0-95.0 vol. %, and the proportion of the at least one water-storing component is 5.0-50.0 vol. %.

16. The stable humus-water storage hybrid product according to claim 15, wherein the proportion of the organic fertilizer is 70.0-90.0 vol. %, and the proportion of the at least one water-storing component is 10.0-30.0 vol. %.

17. The stable humus-water storage hybrid product according to claim 4, wherein the proportion of the organic fertilizer is 5.0-95.0 vol. %, and the proportion of the at least one water-storing component is 5.0-95.0 vol. %.

18. The method according to claim 7, wherein the hybrid product amounts to 0.5-20.0 vol. % of the planting soil.

19. The method according to claim 8, wherein the hybrid product amounts to 0.1-30.0% by weight of the uppermost 20 cm thick soil layer.

20. The method according to claim 10, wherein the proportion of the organic fertilizer is 1.0-90.0 vol. %, and the proportion of the at least one water-storing component is 10.0-99.0 vol. %.
